(19) United States
(12) Patent Application Publication
(10) Pub. No.: US 2025/0328915 A1
(43) Pub. Date: Oct. 23, 2025

(54) MOVING OBJECT AND REMOTE SUPPORT SYSTEM

(71) Applicant: TOYOTA JIDOSHA KABUSHIKI KAISHA, Toyota-shi (JP)

(72) Inventor: Hirofumi MOMOSE, Numazu-shi (JP)

(73) Assignee: TOYOTA JIDOSHA KABUSHIKI KAISHA, Toyota-shi (JP)

(21) Appl. No.: 19/021,213

(22) Filed: Jan. 15, 2025

(30) Foreign Application Priority Data
Apr. 19, 2024 (JP) 2024-068382

(51) Int. Cl. G06Q 30/015; B60W 60/00

(52) U.S. Cl. CPC G06Q 30/015; B60W 60/00; B60W 2556/45

(57) ABSTRACT

A moving object is to receive remote support. The moving object includes a control device and a management device database in which information of a plurality of management devices is registered. Each of the plurality of management devices has a function to assign a support resource necessary for remote support. The control device is configured to transmit a support request to the first management device registered in the management device database, and if a response to the support request is not received from the first management device within the first period from the transmission of the support request, transmit the support request to a second management device registered in the management device database and different from the first management device.

### CROSS-REFERENCE TO RELATED APPLICATION

This application claims priority to Japanese Patent Application No. 2024-068382 filed on Apr. 19, 2024, incorporated herein by reference in its entirety.

### BACKGROUND

### 1. Technical Field

The present disclosure relates to techniques of remotely supporting a moving object.

### 2. Description of Related Art

Japanese Unexamined Patent Application Publication No. 2020-205037 (JP 2020-205037 A) discloses a method for remotely operating a vehicle. In the method disclosed in JP 2020-205037 A, a remote operation is performed via a dispatcher that receives a support request from a vehicle and a control center that assigns a resource necessary for the remote operation.

### SUMMARY

A process to be performed when there are a plurality of devices that receives a support request from a vehicle and a plurality of devices that assigns a necessary resource is not sufficiently considered in this remote support. For example, JP 2020-205037 A does not consider details of a process of selecting a dispatcher and a control center when there are a plurality of dispatchers and a plurality of control centers.

One object of the present disclosure is to provide a technique of appropriately selecting a device that receives a support request from a vehicle and assigns a necessary resource.

A first aspect relates to a moving object that is to receive remote support.
The moving object includes:
a control device; and
a management device database in which information on a plurality of management devices is registered.
Each of the management devices has a function to assign a support resource necessary for the remote support.
The control device is configured to
transmit a support request to a first management device registered in the management device database, and
when a response to the support request is not received from the first management device within a first period from transmission of the support request, transmit the support request to a second management device registered in the management device database and different from the first management device.

A second aspect relates to a remote support system for remote support of a moving object.
The remote support system includes:
one or more processors; and
a plurality of management devices.
Each of the management devices includes a database that stores information on a support resource necessary for the remote support.
The one or more processors are configured to
transmit a support request to a first management device out of the management devices, and when a response to the support request is not received from the first management device within a first period from transmission of the support request, transmit the support request to a second management device out of the management devices. The second management device is different from the first management device.

The control device in the first aspect or the one or more processors in the second aspect transmits the support request to the second management device when a response is not received from the first management device within the first period from transmission of the support request. The remote support system can thus be maintained even when part of the management devices is not functioning.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of remote support for a vehicle;

FIG. 2 is a schematic diagram illustrating an example of a management device selection for a plurality of management devices;

FIG. 3 is a schematic diagram illustrating an example of resource assignment when a plurality of management devices exist;

FIG. 4 is a block diagram illustrating an exemplary configuration of each of a vehicle and a plurality of management devices according to a management device selection; and

FIG. 5 is a schematic diagram illustrating an example of a case where the scale of the remote support system is increased.

### DETAILED DESCRIPTION OF EMBODIMENTS

In the present embodiment, the description will be made based on an example in which the “moving object” is a “vehicle”. The technique of the present disclosure can be applied even if the “vehicle” described below is read as a “moving object” (or generalized). The moving object includes a drone, a robot, a ship, and the like in addition to the vehicle.

### 1. Remote Support System

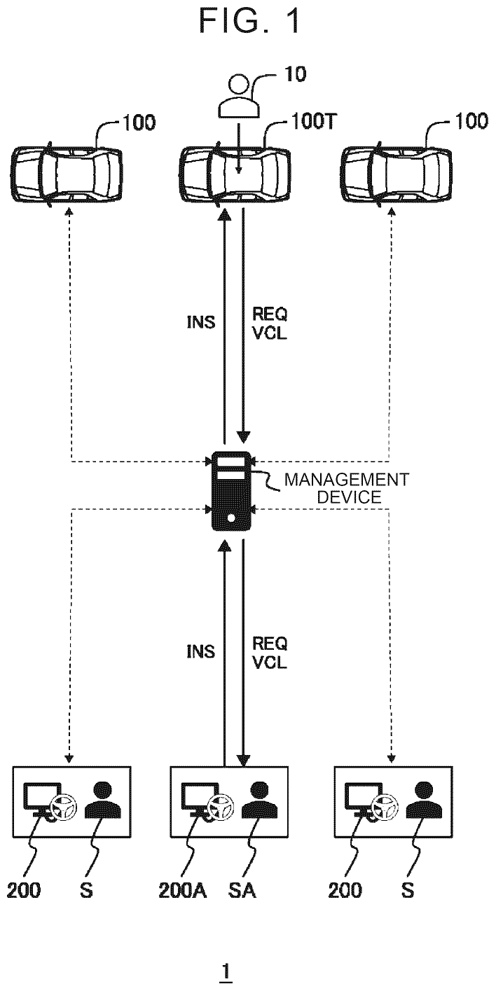

FIG. 1 is a schematic diagram illustrating an example of remote support for a vehicle 100. The remote support is performed by the remote support system 1. The remote support system 1 includes a vehicle 100, a remote support terminal 200, and a management device. The vehicle 100, the remote support terminal 200, and the management device can communicate with each other via a communication network.

Vehicle 100 is subject to remote support. The vehicle 100 may be an autonomous vehicle. As the autonomous driving here, it is assumed that the driver does not necessarily have to concentrate on 100% driving (so-called level 3 or higher autonomous driving). Vehicle 100 may be a level 4 or higher autonomous vehicle that does not require a driver. Various sensors including a camera are mounted on the vehicle 100. For example, the camera captures an image of a situation around the vehicle 100 and acquires an image indicating a situation around the vehicle 100. The vehicle 100 performs automatic driving using various sensors.

Remote support refers to the general intervention of the vehicle 100 by means of a remote supporter S remote from the vehicle 100 via communication. Remote support is a concept that includes remote monitoring, remote assistance, and remote driving. The remote monitoring includes monitoring of an environment around the vehicle 100, a vehicle state of the vehicle 100, a state of an occupant of the vehicle 100, and the like. The remote support means that the remote supporter S instructs the vehicle 100 to travel when there is a request from the vehicle 100. For example, when the vehicle 100, which is an autonomous vehicle, cannot determine appropriate timings such as start, lane change, right or left turn, and the like, a support request is transmitted to the remote support system 1. Upon receiving the support request, the remote supporter S instructs the autonomous vehicle to provide an appropriate timing. The remote driving refers to controlling the traveling of the vehicle 100 based on an operation input by the remote supporter S to the remote support terminal 200.

The remote support terminal 200 is a terminal device used when the remote supporter S performs remote support for the vehicle 100. The remote support terminal 200 may also be referred to as a remote support HMI (Human Machine Interface).

The management device manages remote support. Management of remote support includes assigning a remote supporter S to the vehicle 100 that requires remote support. The management device can communicate with the vehicle 100 and the remote support terminal 200 via a communication network. Typically, the management device is a management server on the cloud. The management server may include a plurality of servers that perform distributed processing.

Typically, a situation in which remote support by the remote supporter S is required is a situation in which automatic driving is difficult. For example, remote support may be required if the camera of the vehicle 100 is unable to recognize the color of the signal at the intersection, or if the timing at which the vehicle 100 changes lanes cannot be determined.

The vehicle 100 requests remote support if it determines that remote support is required. Specifically, the vehicle 100 transmits the support request REQ to the management device. The vehicle 100 that has issued the support request REQ, that is, the vehicle 100 that needs remote support, is hereinafter referred to as “target vehicle 100T”.

The vehicle 100 according to the present embodiment is not limited to an autonomous vehicle. The remote support system 1 is applicable even if the driver or occupant driving the vehicle 100 (manually) requires remote support. In connection, the expression “vehicle 100 requests remote support” in this specification shall also include a case where a driver or an occupant on vehicle 100 requests remote support. A driver or an occupant who boards the vehicle 100 and requests remote support is hereinafter referred to as a “support requester 10”.

In response to the support request REQ from the target vehicle 100T, the management device assigns a support resource required for remote support to remote support of the target vehicle 100T. The support resource means a device or a human resource necessary for remote support, and includes at least a remote supporter S and a remote support terminal 200. The process of assigning the support resource to the remote support of the target vehicle 100T is hereinafter referred to as “resource assignment”. Further, the remote supporter S and the remote support terminal 200 assigned to the remote support of the target vehicle 100T by the resource assignment are referred to as an “assigned supporter SA” and an “assigned support terminal 200A”, respectively.

The management device transmits an assignment notification including the support request REQ and the target vehicle 100T to the assigned support terminal 200A. The assigned support terminal 200A presents the assignment notification to the assignment supporter SA. The assignment supporter SA recognizes that it has been assigned to the target vehicle 100T and initiates remote supporting for the target vehicle 100T.

During remote support, the target vehicle 100T and the assigned support terminal 200A communicate with each other. The target vehicle 100T transmits the vehicle information VCL to the assignment supporting terminal 200A. The vehicle information VCL includes the status of the vehicle 100, images of the surroundings of the vehicle 100 obtained by the cameras, the outcome of the vehicle process, and the like. The assigned support terminal 200A presents the vehicle information VCL received from the target vehicle 100T to the assignment supporter SA. The assignment supporter SA verifies the vehicle information VCL, recognizes the surroundings of the target vehicle 100T, and remotely supports the target vehicle 100T. The supporter instruction INS is an instruction to the target vehicle 100T input by the assigned supporter SA.

In this way, remote support for the vehicle 100 by the remote supporter S is realized. In particular, the present disclosure focuses on a case where the remote support system 1 includes a plurality of management devices (hereinafter, referred to as “a plurality of management devices 300”). Detailed aspects are described below.

### 2. Remote Support System Including Multiple Management Devices

When the remote support system 1 includes the plurality of management devices 300, the target vehicle 100T executes a process of selecting one of the plurality of management devices 300 to be connected to the target vehicle 100T. This process is hereinafter referred to as “management device selection”. In addition, among the plurality of management devices 300, those selected by the management device selection are particularly referred to as “selected management device 300A”. Hereinafter, management device selection and resource assignment when the remote support system 1 includes a plurality of management devices 300 will be described.

### 2-1. Selection of Management Device

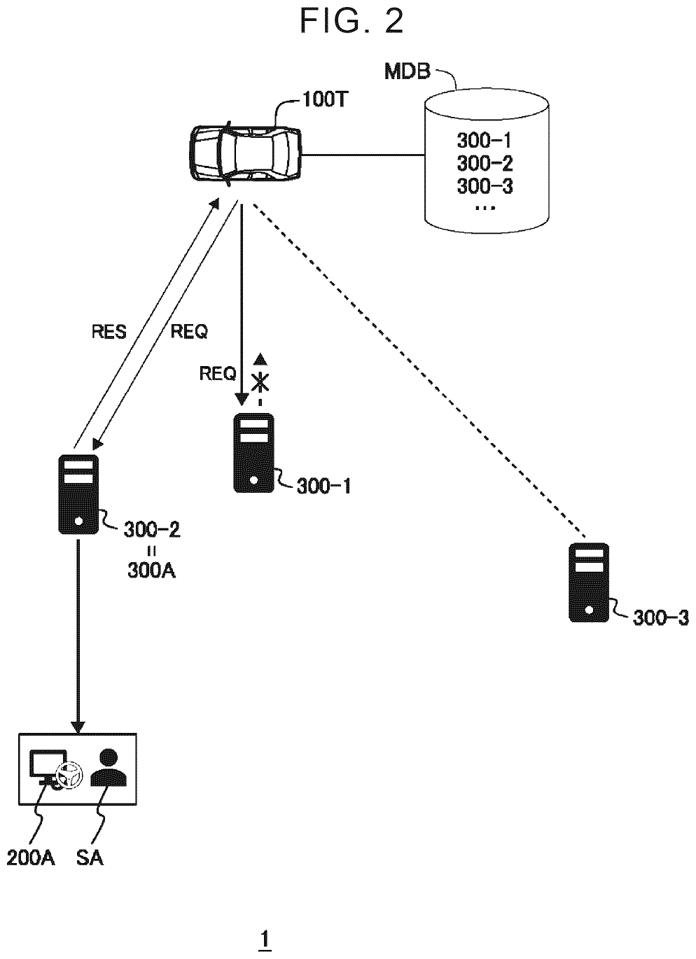

FIG. 2 is a schematic diagram illustrating an example of selection of management devices for the plurality of management devices 300. The target vehicle 100T includes a “management device database MDB”. In the management device database MDB, the connection information (IP address, location, and the like) of each of the plurality of management devices 300 to be selected as the management device is registered. Here, the management device database MDB includes information of the first to third management devices 300-1 to 300-3. When remote support is required, the target vehicle 100T transmits a support request REQ to the first management device 300-1. When the support request REQ is properly received, the first management device 300-1 transmits a response RES notifying the fact to the target vehicle 100T and starts to operate as the selected management device 300A. On the other hand, the target vehicle 100T transmits the support request REQ to the second management device 300-2 that differs from the first management device 300-1 when the response RES from the first management device 300-1 is not received within the first period from the transmission of the support request REQ. For example, when the first management device 300-1 does not function properly due to a failure or maintenance, the response RES is not transmitted and received, and thus the support request REQ is transmitted to the second management device 300-2.

The target vehicle 100T may determine a target to which the support request REQ is to be transmitted based on the priorities set for each of the plurality of management devices 300 registered in the management device database MDB.

The priorities may be linked to distances between the target vehicle 100T and each of the management devices 300. Here, the target vehicle 100T acquires its own position by the position sensor. For example, GNSS (Global Navigation Satellite System) is exemplified as the position sensor. For the plurality of management devices 300, the shorter the distance to the target vehicle 100T, the higher the priority is set. In other words, the target vehicle 100T transmits the support request REQ to the plurality of management devices 300 in ascending order of the distance from the target vehicle 100T. In FIG. 2, it is assumed that a position closest to the target vehicle 100T is the first management device 300-1, and a position closest to the next is the second management device 300-2. Therefore, the target vehicle 100T first transmits the support request REQ to the first management device 300-1. When the target vehicle 100T does not receive the response RES from the first management device 300-1 within the first period, it transmits a support request REQ to the second management device 300-2. When the second management device 300-2 receives the support request REQ and the target vehicle 100T receives the response RES, the second management device 300-2 starts to operate as the selected management device 300A. The third management device 300-3 does not transmit the support request REQ. If the target vehicle 100T does not receive the response RES from the second management device 300-2 within the first period, the target vehicle 100T transmits the support request REQ to the third management device 300-3.

As described above, the management device selection refers to a series of processes in which the target vehicle 100T sequentially transmits the support request REQ to the plurality of management devices 300 to determine the selected management device 300A. The selected management device 300A performs resource assignment, and assigns the assigned supporter SA and the assigned supporting terminal 200A to the target vehicle 100T.

### Effects

When the target vehicle 100T selects the selected management device 300A from among the plurality of management devices 300, the remote support system 1 can be maintained even when part of the management devices 300 is not functioning. In other words, it can be said that the redundancy and the service continuity of the remote support system 1 are improved by adopting the management device selection.

Further, when the support request REQ is transmitted preferentially to a target whose distance from the target vehicle 100T is short, a situation in which communication with a target located in a long distance is performed is unlikely to occur. Therefore, the remote support system 1 contributes to reduction in waste of communication resources associated with telecommunications.

### 2-2. Resource Assignment

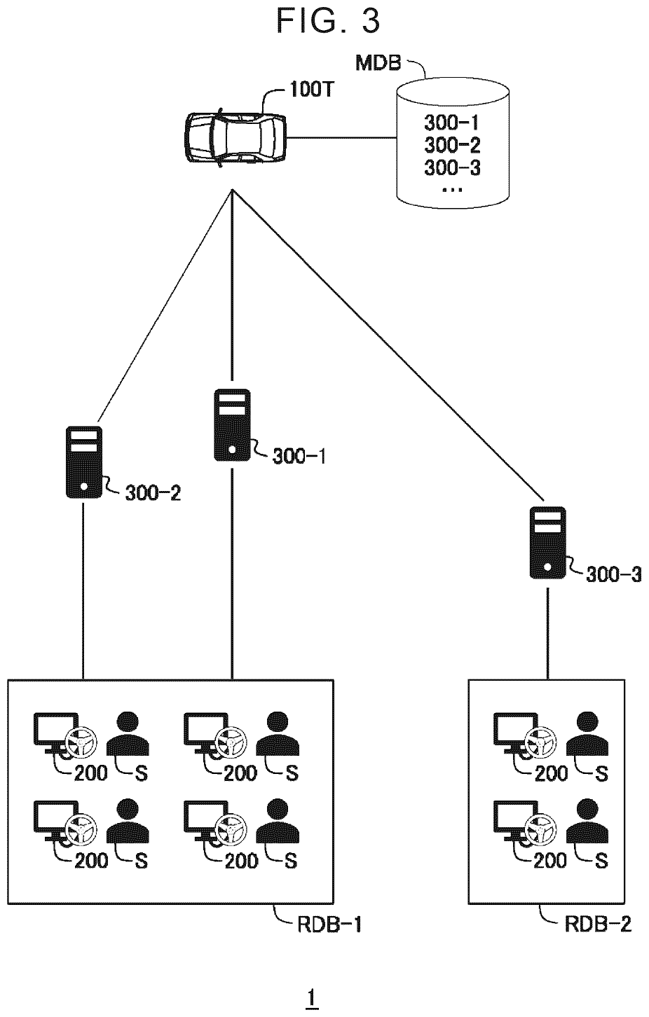

FIG. 3 is a schematic diagram illustrating an example of resource assignment in a case where there is a plurality of management devices 300. Each of the plurality of management devices 300 includes a resource database RDB that stores information about a supporting resource. The information related to the support resource includes supporter information SI that is information related to each of the remote supporters S and terminal information TI that is information related to each of the remote support terminals 200. Examples of the supporter information SI include availability, experiences in remote support, licensing information, and the like. Further, the terminal information TI includes information such as an available state, the number of displays provided, and the performance of the input/output device.

In addition, the resource database RDB manages each of the remote supporters S and the remote support terminals 200 accessible by each of the remote supporters S in association with each other. In this case, the correspondence between the remote supporter S and the remote support terminal 200 need not be one-to-one. For example, when one of the remote supporters S has a plurality of remote support terminals 200, a plurality of remote support terminals 200 are associated with one of the remote supporters S. In the case of a facility (remote support center) including a large number of remote supporters S and remote support terminals 200, all of the remote supporters S belonging to the remote support center is associated with the all of the remote support terminals 200.

The resource database RDB may be shared among the plurality of management devices 300. In FIG. 3, the first resource database RDB-1 is shared between the first management device 300-1 and the second management device 300-2. On the other hand, the second resource database RDB-2 is used only by the third management device 300-3.

As described above, the remote support system 1 may include a plurality of management devices 300. Here, the resource assignment refers to a process in which the management device 300 assigns a particular support resource (including an assigned supporter SA and an assigned support terminal 200A) from the resource database RDB to the remote support.

### Effect

When each of the plurality of management devices 300 includes the resource database RDB, the selected management device 300A can assign the alternative resource even when some of the remote supporters S and the remote support terminal 200 are unavailable. That is, it can be said that the redundancy and the service continuity of the remote support system 1 are further improved by the resource assignment.

### 3. Configuration Example for Management Device Selection

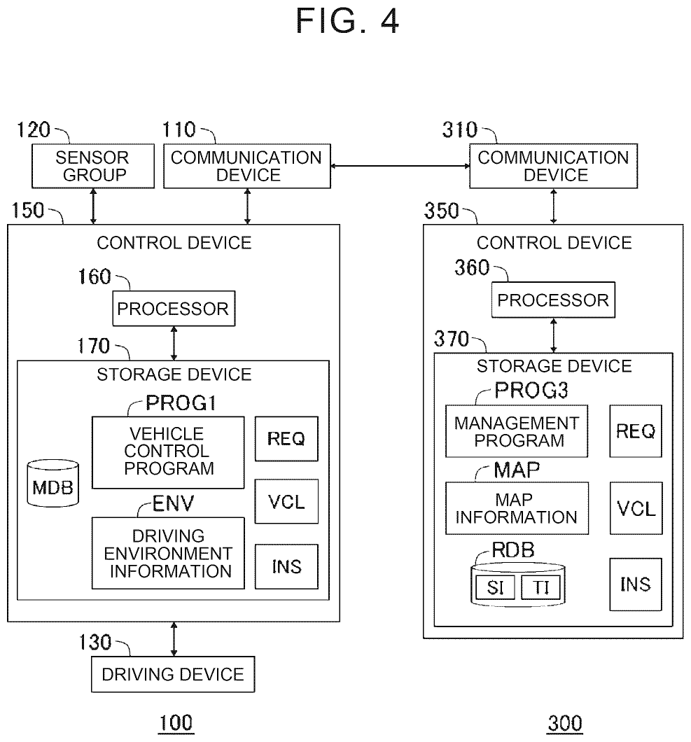

FIG. 4 is a block diagram illustrating a configuration example of each of the vehicles 100 and the plurality of management devices 300 according to the management device selection.

### 3-1. Vehicle

The vehicle 100 includes a communication device 110, a sensor group 120, a traveling device 130, and a control device 150.

The communication device 110 communicates with the outside of the vehicle 100. For example, the communication device 110 communicates with the remote support terminal 200 and the plurality of management devices 300.

The sensor group 120 includes a recognition sensor, a vehicle state sensor, a position sensor, and the like. The recognition sensor recognizes (detects) a situation around the vehicle 100. Examples of recognition sensors include cameras, LIDAR (Laser Imaging Detection and Ranging), radars, and the like. The vehicle state sensor detects a state of the vehicle 100. The vehicle state sensor includes a speed sensor, an acceleration sensor, a yaw rate sensor, a steering angle sensor, and the like. The position sensor detects the position and azimuth of the vehicle 100. For example, the position sensor includes a GNSS (Global Navigation Satellite System).

The traveling device 130 includes a steering device, a driving device, and a braking device. The steering device will turn the wheel. For example, the steering device includes a power steering (EPS: Electric Power Steering) device. The driving device is a power source that generates a driving force. Examples of the driving device include an engine, an electric motor, and an in-wheel motor. The braking device generates a braking force.

The control device 150 is a computer that controls the vehicle 100. The control device 150 includes one or more processors 160 (hereinafter simply referred to as processors 160) and one or more storage devices 170 (hereinafter simply referred to as storage devices 170). The processor 160 may also be referred to as a processing circuit. The processor 160 executes various processes. For example, the processor 160 includes a CPU. The storage device 170 stores various kinds of information necessary for processing by the processor 160. Examples of the storage device 170 include a volatile memory, a nonvolatile memory, and an HDD, SSD. The control device 150 may include one or more ECUs (Electronic Control Units).

The vehicle control program PROG1 is a computer program executed by the processor 160. When the processor 160 executes the vehicle control program PROG1, the function of the control device 150 is realized. The vehicle control program PROG1 is stored in the storage device 170. Alternatively, the vehicle control program PROG1 may be recorded in a computer-readable recording medium.

The management device database MDB includes the connection information of each of the plurality of management devices 300 that can be the target of the management device selection.

The control device 150 uses the sensor group 120 to acquire driving environment information ENV indicating the driving environment of the vehicle 100. The driving environment information ENV is stored in the storage device 170. The driving environment information ENV includes surrounding situation information indicating a recognition result by the recognition sensor. For example, the surrounding situation information includes an image captured by the camera. The driving environment information ENV includes vehicle state information indicating a vehicle state detected by the vehicle state sensor.

Further, the driving environment information ENV includes vehicle position information indicating a position and an azimuth of the vehicle 100. The vehicle position information is obtained by a position sensor. Highly accurate vehicle position information may be acquired by a self-position estimation process (Localization) using map information and surrounding situation information (object information).

The control device 150 executes vehicle travel control for controlling travel of the vehicle 100. The vehicle travel control includes steering control, drive control, and braking control. The control device 150 executes vehicle travel control by controlling the traveling device 130 (a steering device, a driving device, and a braking device). The control device 150 may perform autonomous driving control based on the driving environment information ENV.

A case where remote support for the vehicle 100 is performed will be described. The control device 150 refers to the management device database MDB and executes the management device selection. The control device 150 can communicate with each of the plurality of management devices 300 via the communication device 110. The outline of the selection of the management device is as described in Section 2-1 above. For example, during the autonomous driving control, the control device 150 determines whether the autonomous driving control is difficult based on the driving environment information ENV. When the autonomous driving control is difficult, the control device 150 transmits the support request REQ to the first management device 300-1. If the response RES is not received from the first management device 300-1 within the first period, the control device 150 transmits a support request REQ to the second management device 300-2.

In addition, the control device 150 may transmit the vehicle information VCL together with the support request REQ. The vehicle information VCL is information required for remote supporting by the remote supporter S and includes at least a part of the driving environment information ENV. For example, the vehicle information VCL includes surrounding condition information. The vehicle information VCL may further include vehicle status information, vehicle position information, a travel plan, and the like.

### 3-2. Management Device

Each of the plurality of management devices 300 includes a communication device 310 and a control device 350. The communication device 310 communicates with the vehicle 100 and the remote support terminal 200. The control device 350 controls cach of the plurality of management devices 300. The control device 350 includes one or more processors 360 (hereinafter simply referred to as processors 360) and one or more storage devices 370 (hereinafter simply referred to as storage devices 370). The processor 360 may also be referred to as a processing circuit. The processor 360 executes various processes. For example, the processor 360 includes a CPU (Central Processing Unit). The storage device 370 stores various kinds of information necessary for processing by the processor 360. Examples of the storage device 370 include volatile memory, non-volatile memory, HDD (Hard Disk Drive), SSD (Solid State Drive), and the like.

The control program PROG3 is a computer program executed by the processor 360. When the processor 360 executes the control program PROG3, the function of the control device 350 is realized. The control program PROG3 is stored in the storage device 370. Alternatively, the control program PROG3 may be recorded on a computer-readable recording medium. The administrative program PROG3 may be provided over a network.

Further, the storage device 370 stores a resource database RDB. The resource database RDB stores and manages the support resources required for remote support. The resource database RDB includes at least a supporter information SI and a terminal information TI.

The control device 350 communicates with the vehicle 100 and the remote support terminal 200 via the communication device 310. The control device 350 receives the support request REQ and the vehicle information VCL transmitted from the target vehicle 100T. The support request REQ and the vehicle information VCL are stored in the storage device 370. The control device 350 refers to the resource database RDB and performs resource assignment for assigning a particular support resource to the target vehicle 100T. The summary of resource assignment is as described in Section 2-2 above.

The control device 350 transmits an assignment notification including the support request REQ and the target vehicle 100T to the assigned support terminal 200A. Responsive to the assignment notification, the assignment supporter SA provides remote support for the target vehicle 100T.

During remote supporting, the control device 350 may receive the vehicle information VCL from the target vehicle 100T. The vehicle information VCL is stored in the storage device 370. The control device 350 may transmit the received vehicle information VCL to the assigned supporting terminal 200A.

The control device 350 receives the supporter instruction INS transmitted from the assigned supporting terminal 200A. The supporter instruction INS is stored in the storage device 370. The control device 350 transmits the received supporter instruction INS to the target vehicle 100T.

### 4. Large-Scale Remote Support System

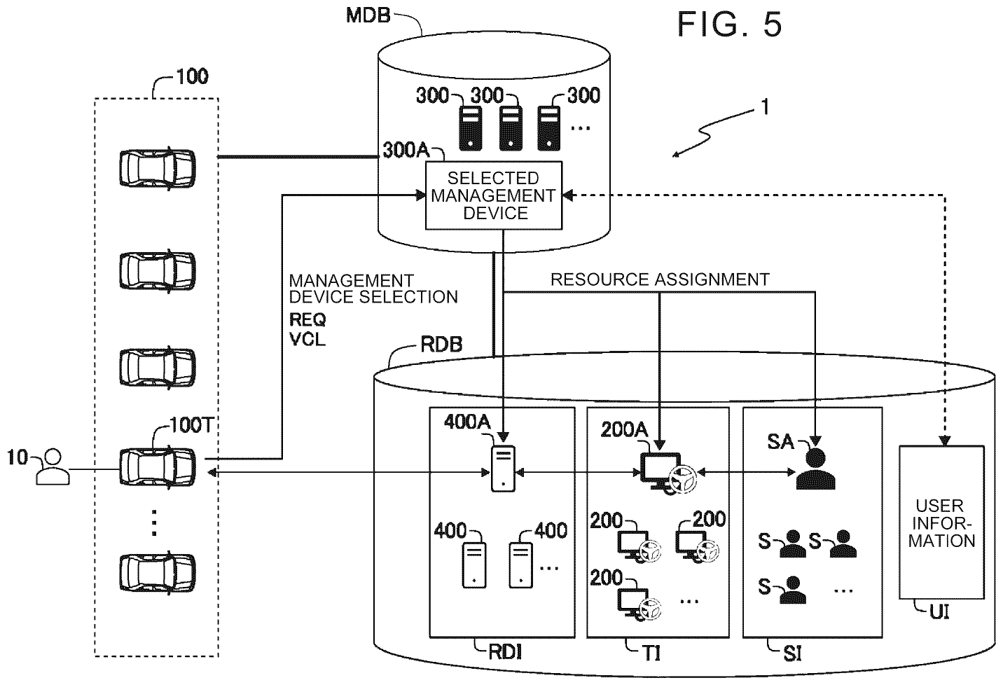

FIG. 5 is a schematic diagram illustrating an example of a case where the scale of the remote support system 1 is increased. Here, it is assumed that the remote support system 1 is managed and operated by a base (which may also be referred to as a remote support center) to which a large number of remote supporters S and remote support terminals 200 belong, and is provided as a service. The remote support system 1 comprises a management device database MDB and a resource database RDB. The vehicle 100 is accessible to the management device database MDB, and the management device database MDB may be shared among the vehicles 100.

When the remote support is started, the target vehicle 100T first performs the management device selection. The support request REQ sent at the time of selecting the management device indicates that remote support is required. In addition, the support request REQ may include vehicle ID and position information of the vehicle 100, identification information of the support requester 10 (user ID to be described later), content of a required remote support, and the like. Next, the selected management device 300A performs resource assignment. The outline of the selection of the management device and the resource assignment is as described above.

In addition to the above-described supporter information SI and terminal information TI, various kinds of information may be stored in the resource database RDB. For example, information of the vehicle 100 or the user (for example, ID of the vehicle 100 or ID of the user) that can be the target of the service may be registered in advance. A user is a person who receives a service. The support requester 10 means a user who transmits the support request REQ.

In addition to the remote supporter S and the remote support terminal 200, a relay device 400 may be included as a support resource. The relay device 400 is a device that relays communication between the target vehicle 100T and the assigned support terminal 200A during remote support. The relay device 400 is provided separately from the management device 300. In principle, the management device 300 can also function as the relay device 400.

The relay device information RDI, which is information related to the relay device 400, is also stored in the resource database RDB. The relay device 400 is also subject to resource assignment by the selection and management device 300A. In FIG. 5, the relay device 400 assigned to the remote support is referred to as an assigned relay device 400A.

What is claimed is:

1. A moving object that is to receive remote support, the moving object comprising:
a control device; and
a management device database in which information on a plurality of management devices is registered, wherein:
each of the management devices has a function to assign a support resource necessary for the remote support; and
the control device is configured to
transmit a support request to a first management device registered in the management device database, and
when a response to the support request is not received from the first management device within a first period from transmission of the support request, transmit the support request to a second management device registered in the management device database and different from the first management device.

2. The moving object according to claim 1, wherein:
the control device is configured to set priorities for each of the management devices when transmitting the support request; and
the control device is configured to select the first management device and the second management device according to the priorities.

3. The moving object according to claim 2, wherein:
the priorities are linked to distances between the moving object and each of the management devices; and
the priority is higher as the distance is shorter.

4. A remote support system for remote support of a moving object, the remote support system comprising:
one or more processors; and
a plurality of management devices, wherein:
each of the management devices includes a database that stores information on a support resource necessary for the remote support; and
the one or more processors are configured to
transmit a support request to a first management device out of the management devices, and
when a response to the support request is not received from the first management device within a first period from transmission of the support request, transmit the support request to a second management device out of the management devices, the second management device being different from the first management device.

5. The remote support system according to claim 4, wherein the database is configured to be shared by the management devices.
